(19) United States
(12) Patent Application Publication
(10) Pub. No.: US 2014/0179229 A1
(43) Pub. Date: Jun. 26, 2014

(54) PEER-TO-PEER WIRELESS TRANSMISSION SYSTEM AND METHOD THEREOF

(71) Applicant: ARTHUR LIN, TAIPEI (TW)

(72) Inventor: ARTHUR LIN, TAIPEI (TW)

(21) Appl. No.: 13/726,232

(22) Filed: Dec. 24, 2012

(51) Int. Cl. H04W 84/10

(52) U.S. Cl. CPC H04W 84/10
USPC 455/41.2

(57) ABSTRACT

A peer-to-peer wireless transmission system and method uses an application program of a first system to carry out the steps of automatically searching a second system or a third system in an environment, reading and recording an identification code of the second or third system, transmitting a connection request and a set parameter from the first system according to a click of the application program, such that the second or third system performs a system installation and a network configuration, and authorizing an online connection after comparing and confirming the identification code of the first system to control data transmission or synchronization between the first system and the second or third system or control the first system to authorize the data transmission or synchronization between the second and third systems, so as to improve the mobility, timeliness and convenience of the data transmission.

### BACKGROUND OF THE INVENTION

1. Field of the Invention

The present invention relates to the technical field of wireless transmission systems, and more particularly to the peer-to-peer wireless transmission system and method with the function of transmitting data through a zero configuration setting and an automatic Wi-Fi Direct method to simplify the complexity of setting up the connection between two electronic products, so as to improve the convenience of operation and the timeliness of data exchange.

2. Description of the Related Art

As portable electronic products are used extensively for transferring or backing up data stored in each electronic product, major technological companies including Microsoft, Intel and Sony have promoted the technology of a Digital Living Network Alliance (DLNA) architecture for the Ethernet and Wi-Fi 802.11 a/b/g/n standard to allow DLNA devices such as PS3, XBOX, audio player or other electronic products to be connected to a router and then electrically coupled to a remote computer, so that the remote computer can share the data stored in the DLNA device. However, the file format of the DLNA is limited, thus reducing the practicality significantly. In addition, the router has the issue of requiring a complicated setup procedure for connection and use, thus resulting in difficult applications and low user-friendliness.

To overcome the aforementioned problems, various different wireless transmission systems and methods R.O.C. Pat. Nos. 200937907, I262678, and 201141151 to meet the IEEE 802.11 standard were disclosed to allow two systems to perform high-speed peer-to-peer (P2P) data transmissions. Wherein, the R.O.C. Pat. No. 200937907 disclosed a method for operating and controlling a remote communication device such as a television, an air-conditioner or an electric fan by a controlling end through a controlled end. The R.O.C. Pat. No. I262678 disclosed a P2P communication after the format of messages is converted by different communication software, and the R.O.C. Pat. No. 201141151 disclosed a method to overcome the problem of having a communication delay when the connection between one-to-many systems is switched. However, these patented technologies combine the use of router or relay and result in complicated system architecture and high cost. Furthermore, the applications including two-way data synchronization, retrieval between two systems or between two systems and a third-party system cannot be achieved.

In view of the aforementioned problems, it is a main subject for the present invention to use a transmission method with the Wi-Fi Direct specification, such that a transmission device situated in an area other than the network coverage area to perform high-speed data transmission without requiring an access point (AP), so as to simplify the connection setting procedure of the electronic products of two-parties or even three parties and the procedure of operating and controlling the data transfer between these electronic products, so as to achieve the effects of providing a simple, easy and convenient application and improve the mobility, timeliness and convenience of the data transfer or backup.

### SUMMARY OF THE INVENTION

In view of the problems of the prior art, it is a primary objective of the present invention to overcome the problems by providing a peer-to-peer wireless transmission system and method thereof, such that after a zero configuration setting between two system is completed, an online connection can be established directly through a Wi-Fi Direct communication method and provided for a user to control and operate an electronic product such as a mobile phone, a tablet PC, a stereo, a private data backup device to execute a data synchronization or a digital media data transmission in an environment from a remote end easily, so as to achieve a simple and easy operation and meet the requirements of practical applications.

To achieve the aforementioned objective, the present invention provides a peer-to-peer wireless transmission system comprising a first system and a second system, wherein the first system has a first identification code and an application program installed in the first system, and the second system has an identification unit, a transmission unit, a processing unit and a second identification code, and the transmission unit is electrically coupled to the first system and the identification unit, and the processing unit is electrically coupled to the identification unit and the transmission unit. The first system communicates with the second system through a Transmission Control Protocol/Internet Protocol (TCP/IP) Wi-Fi Direct method, and the peer-to-peer wireless transmission system is operated by a procedure comprising the following steps: The application program and the second system are started. The application program automatically searches the second system to read the second identification code and check a built-in direct connection list. If no data is recorded in the built-in direct connection list, a connection request having the first identification code and a set parameter having a PIN code are transmitted to the second system, and the second system receives the connection request through the transmission unit, and the identification unit automatically checks a built-in security list. If no data is recorded in the built-in security list, the first identification code is recorded, and the set parameter is used for establishing a direct connection with the first system after performing a system installation and setting a network configuration, while the first system records the second identification code into the built-in direct connection list. If the first identification code is recorded correspondingly in the built-in security list, then the connection request is received to establish the direct connection. On the other hand, if a non-corresponding first identification code is recorded, the first system is requested to provide the PIN code in order to establish the direct connection after the confirmation. If the second identification code is recorded in the built-in direct connection list, the first system transmits the connection request to the second system according to the second identification code, and if the second system confirms that the corresponding first identification code is recorded in the built-in security list, a direct connection is established. If no data is recorded in the built-in security list, the first identification code is recorded, and the first system is requested to perform a setup and an online connection after providing the set parameter; and the application program is clicked, so that the first system transmits a service request to the second system to perform the data transmission or synchronization.

Wherein, if one single first identification code and one single PIN code are recorded in the built-in security list, and plural second systems are used, the first system uses the application program to define one of the second identification codes as a record of the built-in direct connection list, and sets an automatic scheduling procedure. When the automatic scheduling procedure is triggered, the first system automatically authorizes an online connection to the second system corresponding to the record of the built-in direct connection list.

### BRIEF DESCRIPTION OF THE DRAWINGS

FIG. 1 is a system block diagram of a first implementation mode of a preferred embodiment of the present invention;

FIGS. 2A and 2B are flow charts of a method of the first implementation mode of a preferred embodiment of the present invention;

FIG. 3 is a schematic view of an application of a second implementation mode of a preferred embodiment of the present invention;

FIG. 4 is a schematic view of an application of a third implementation mode of a preferred embodiment of the present invention; and

FIGS. 5A, 5B and 5C are flow charts of a method of the third implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

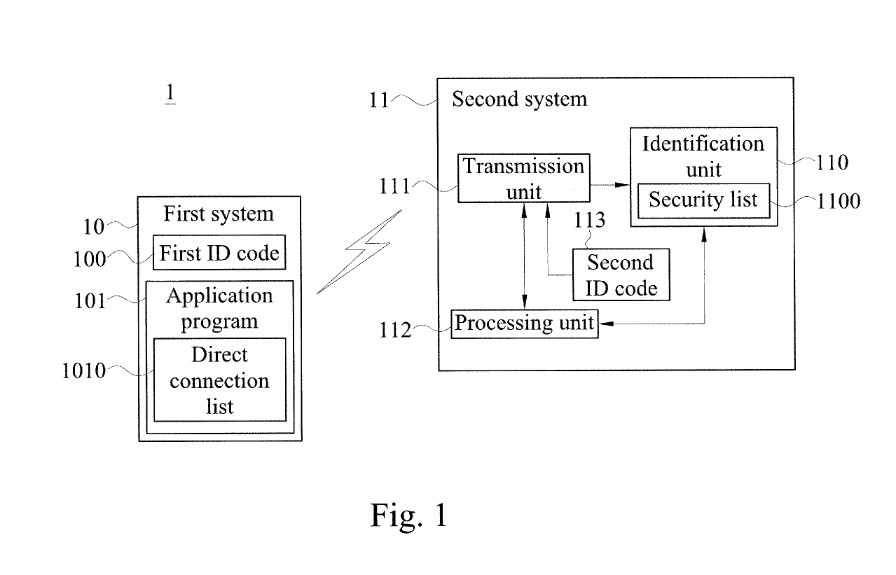

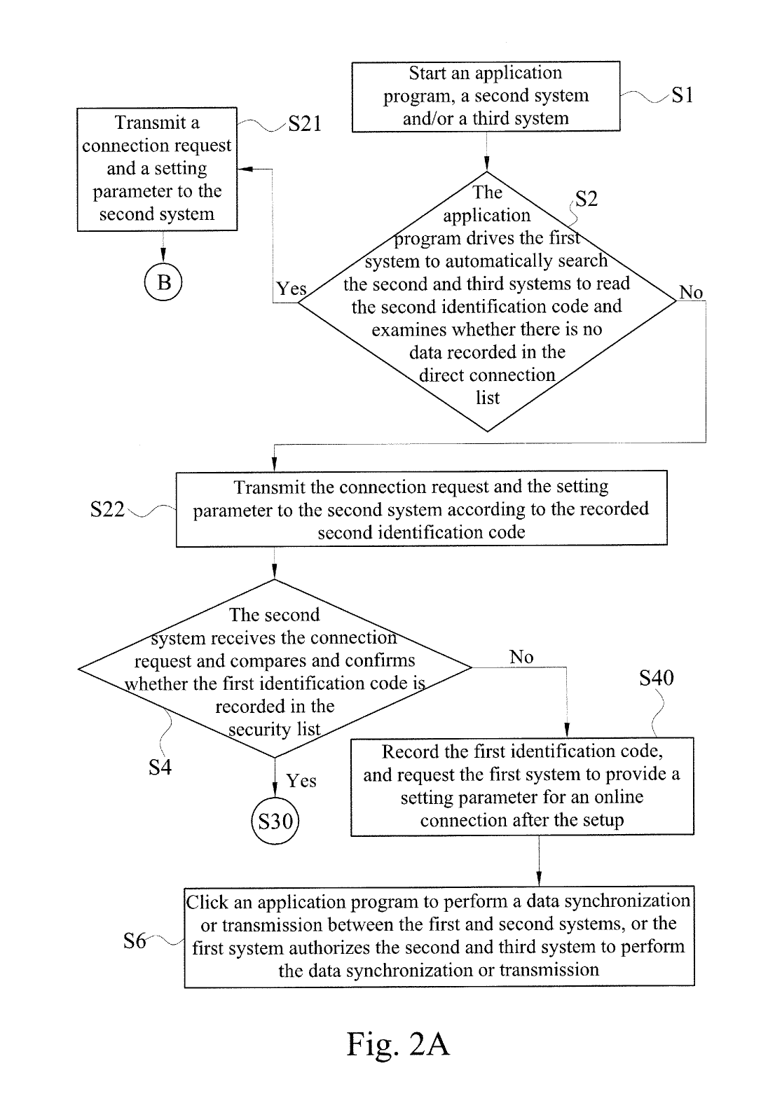

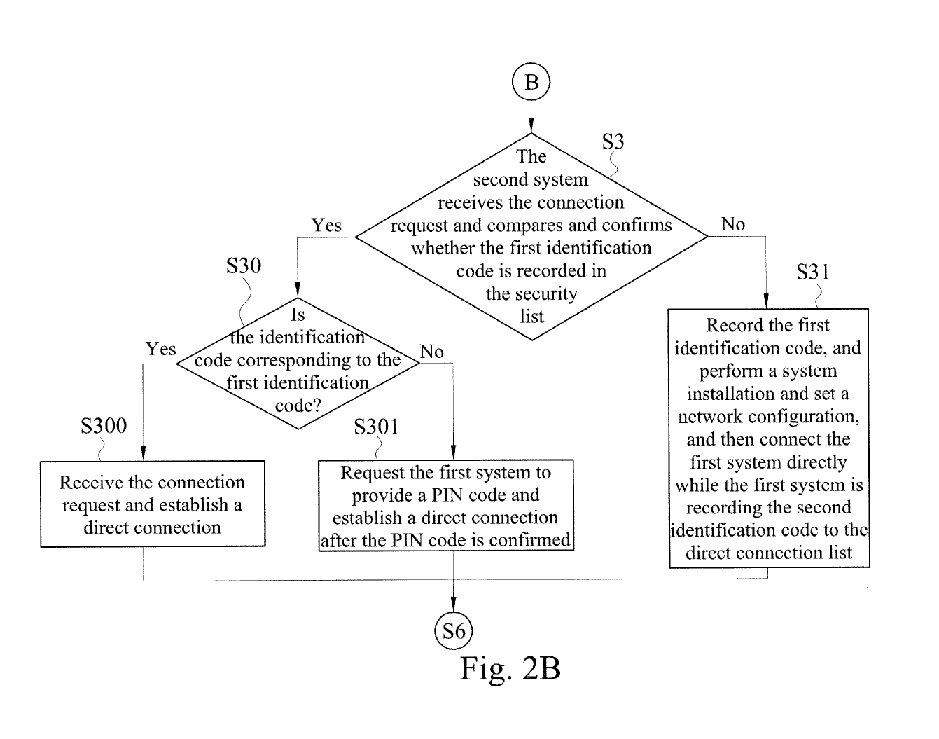

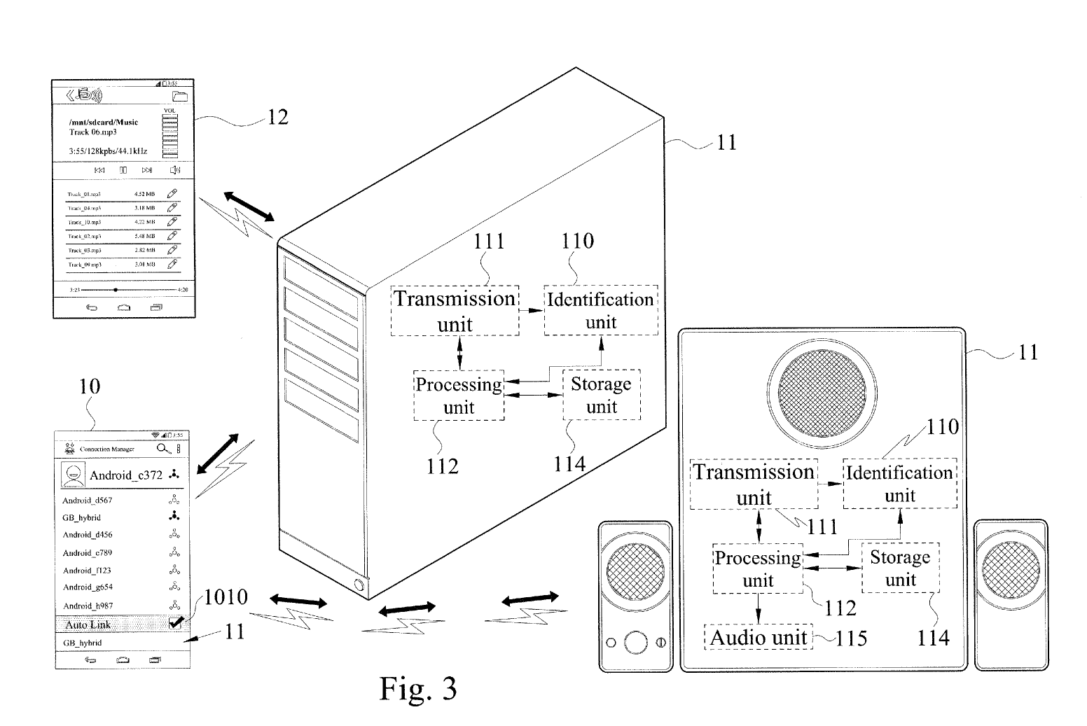

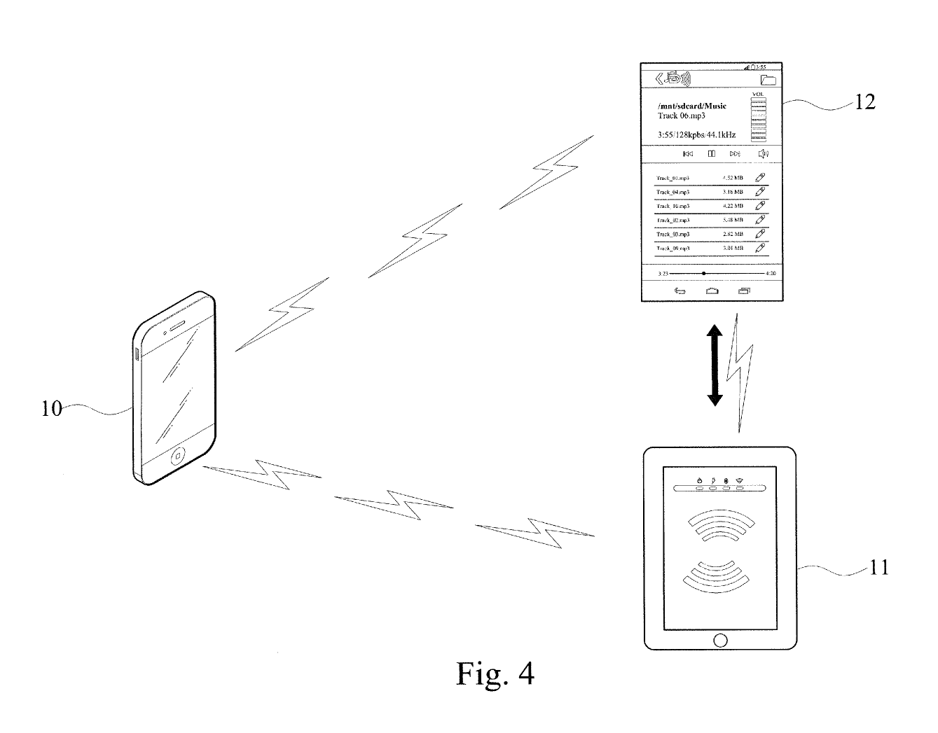

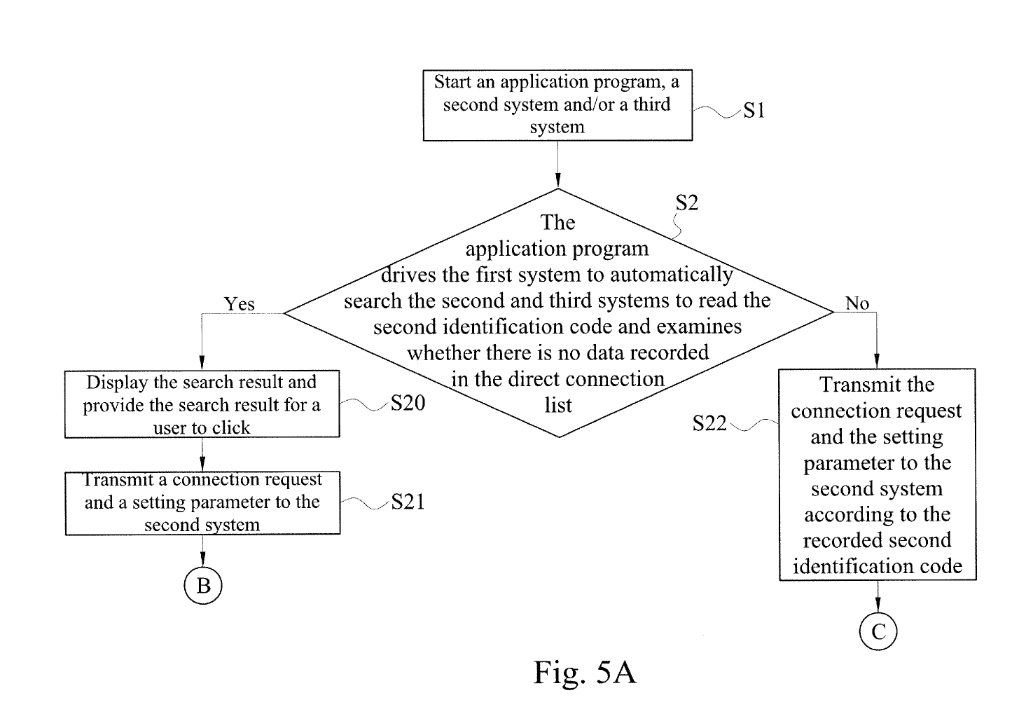

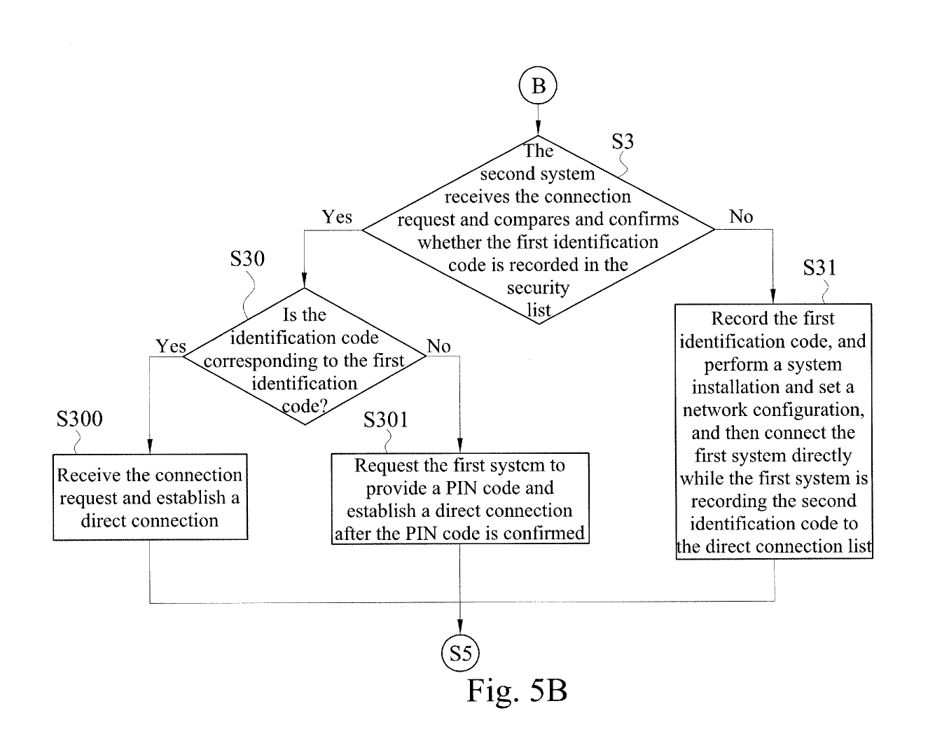

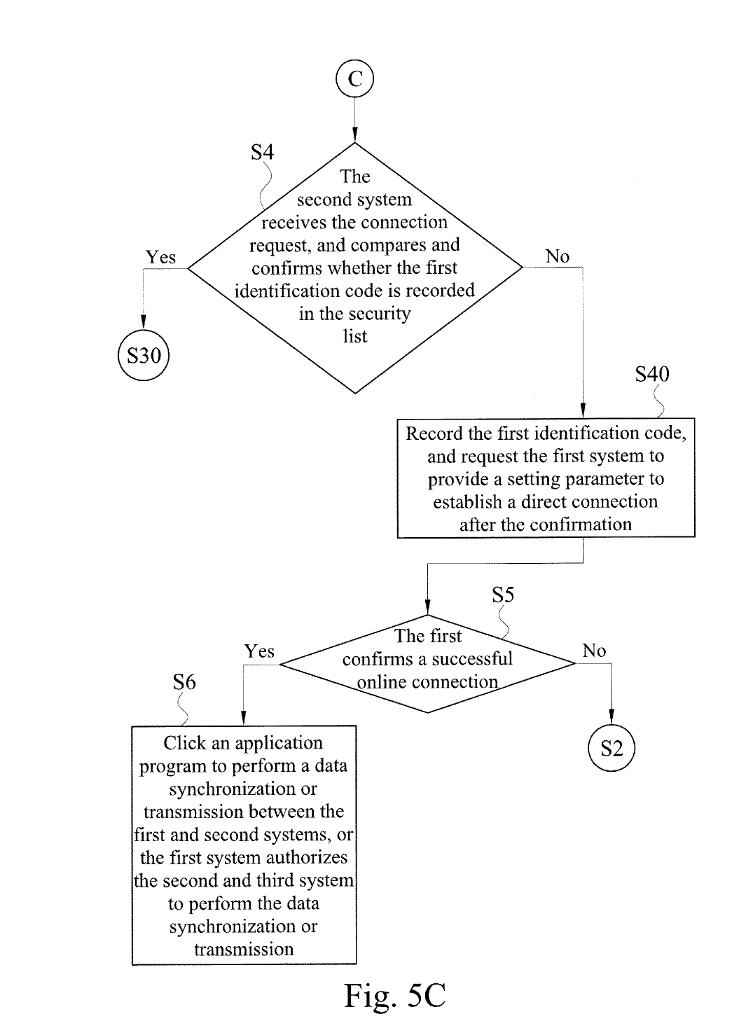

With reference to FIGS. 1 to 5C for a system block diagram and flow charts of a method of the first implementation mode, a schematic view of an application of the second implementation mode, a schematic view of an application and flow charts of a method of the third implementation mode of a preferred embodiment of the present invention respectively, the peer-to-peer wireless transmission system 1 is provided for users to control and operate a function such as synchronizing, retrieving or executing data between various types of electronic products easily, and the peer-to-peer wireless transmission system 1 comprises a first system 10 and a second system 11, or further comprises a third system 12, wherein the first system 10, the second system 11, and the third system 12 respectively include a first identification code 100, a second identification code 113 and a third identification code (not shown in the figure) such as a device ID, a website, a system serial number or a service set identifier (SSID), and one or more of the first system 10, the second system 11, and the third system 12 can be used in an environment.

The first system 10 and the third system 12 can be electronic products such as Smartphones or computers installed with an application program 101, and the application program 101 has a built-in direct connection list 1010 to record the second identification code 113. The second system 11 having a WLAN chip installed thereon comprises an identification unit 110, a transmission unit 111, a processing unit 112, the second identification code 113, a storage unit 114 and/or an audio unit 115, and the second system 11 can be combined with a Bluetooth chip, an NFC chip, a GPS chip, a wireless power supply chip, a RFID chip, or any combination of the above, so that the second system 11 can be a server, a broadcasting device, a navigation device, a data storage box, a mobile phone, a computer or a television in accordance with the present invention. The processing unit 112 can be a processor with ARM as the core architecture, and the processing unit 112 is electrically coupled to the identification unit 110, the transmission unit 111, the storage unit 114 and/or the audio unit 115, and the transmission unit 111 is electrically coupled to the identification unit 110 and further electrically coupled to the first system 10 and third system 12 through a TCP/IP Wi-Fi Direct method, and the identification unit 110 has a built-in security list 1100 for recording one single first identification code 100 and a personal information number (PIN) code, wherein the PIN code is a security password set by a user during the first time of connecting the two systems.

In this preferred embodiment, the application program 101 can automatically define an initially recorded identification code or receive a user-defined identification code as the only record of the built-in direct connection list 1010, and the application program 101 is provided for the user to set an automatic scheduling procedure, such that when the application program 101 is started or an NFC authorization, a RFID code authentication or a fixed time point is triggered, the first system 10 is driven to automatically authorize and connect the second system 11 corresponding to the record of the built-in direct connection list 1010. Therefore, the user can automatically transmit or synchronize media data, text files or other data with the second system 11 without requiring the control and operation of the first system 10, so as to enhance the convenience of use and improve the timeliness, integrity, security and privacy of the data backup.

In view of the description above, the peer-to-peer wireless transmission system 1 meets the requirement or the user's using habit of using each electronic product alternately and control a remote device through a mobile phone to perform an operation such as an audio playback or a data backup easily. The operation flow comprises the following steps.

S1: Start the application program 101, the second system 11 and/or the third system 12.

S2: Drive the first system 10 to automatically search the second and third systems 11, 12 within a range by the application program 101 to read the second identification code 113 such as a GB hybrid and the third identification code (not shown in the figure), while examining whether there is no record in a built-in direct connection list 1010 or there is no trigger of the automatic scheduling procedure and an operation instruction manually issued by the user is waited. If yes, go to Step S20.

S20: Display all of search results on a screen by the application program 101, and provide the search results for the user to click. If no data is recorded in the built-in direct connection list 1010, then the procedure carries out the Step S21.

S21: Transmit a connection request having the first identification code 100 such as Android c372 and the set parameter having the PIN code to the initially searched or manually specified to the second system 11 by the application program 101, or even transmit the connection request to the manually clicked third system by the application program 101. On the other hand, if data are recorded in the built-in direct connection list 1010 or the automatic scheduling procedure is trigger, the procedure carries out the Step S22.

S22: Transmit the connection request correspondingly to the second system 11 according to the second identification code 113 recorded by the first system 10.

The procedure carries out the Step S3 after the Step S21 takes place.

S3: Connect the first system 10 by the third system 12 after receiving the connection request, and compare the built-in security list 1100 through the identification unit 110 by the second system 11 after the connection request is received through the transmission unit 111, so as to confirm whether the first identification code 100 is listed. If yes, the procedure carries out the Step S30.

S30: Determine whether the identification code is correspondingly the first identification code 100. If yes, the procedure carries out the Step S300.

S300: Receive the connection request and feed back an authorization acknowledge by the second system 11 to establish a direct connection. On the other hand, if the record is non-corresponding to the first identification code 100, the procedure carries out the Step S301.

S301: Request the first system 10 to provide the PIN code, and establish a direct connection after the PIN code is confirmed. If no data is recorded in the built-in security list 1100, the procedure carries out the Step S31.

S31: Record the first identification code 100 in the built-in security list 1100, and use the set parameter to perform a system installation and set a network configuration, and then feed back the authorization acknowledge to establish a direction connection with the first system 10. In the meantime, the first system 10 records the second identification code 113 in the built-in direct connection list 1010.

After the Step S22 takes place, the procedure carries out the Step S4.

S4: Connect the third system 12 with the first system 10, and compare the built-in security list 1100 after the second system 11 receives the connection request to confirm whether the first identification code 100 is listed. If yes, the procedure carries out the Step S30. On the other hand, if no data is recorded in the built-in security list 1100, the procedure carries out the Step S40.

S40: Record the first identification code 100 and request the first system 10 to provide the set parameter to perform a system installation and set a network configuration. Feed back the authorization acknowledge, and establish the direct connection of the first system 10.

S5: Perform an analysis by the first system 10 to confirm whether the connection is succeeded, after the first system 10 receives the authorization acknowledge. If yes, the procedure goes to Step S6.

S6: Click the application program 101 to transmit a service request to the second system 11 or the third system 12 after the online connection is succeeded, so that the first system 10 and the second system 11 can synchronize or transmit data, or the first system 10 uses the application program 101 to output the PIN code to the third system 12 to authorize the third system 12 to transmit or synchronize data correspondingly with the second system 11, so that the first system 10 can perform related data service operation through the second system 11 and the third system 12. Or else, the procedure returns to the step S2.

It is noteworthy that the data are original or lossless compression audio stream data, so that the second system 11 of a broadcasting device can drive the audio unit 114 to convert the data to the original video data for a direct playback according to the service request without requiring encoding or decoding, so as to improve the execution perforniance and quality of the second system 11. To enhance the security of the data transmission, the processing unit 112 further includes an encoding/decoding part (not shown in the figure) for storing and transmitting encrypted or decrypted source code data according to the set parameter.

What is claimed is:

1. A peer-to-peer wireless transmission system, comprising a first system and a second system, and the first system having a first identification code and an application program installed in the first system, and the second system having an identification unit, a transmission unit, a processing unit and a second identification code, and the transmission unit being electrically coupled to the first system and the identification unit, and the processing unit being electrically coupled to the identification unit and the transmission unit, and the first system communicating with the second system through a TCP/IP Wi-Fi Direct method, characterized in that:
when the application program is started, the application program automatically searches the second system to read the second identification code and check a built-in direct connection list, and if no data is recorded in the built-in direct connection list, a connection request having the first identification code and a set parameter having a PIN code are transmitted to the second system, and the second system receives the connection request through the transmission unit, and the identification unit automatically checks a built-in security list, and if no data is recorded in the built-in security list, the first identification code is recorded, and the set parameter is used for establishing a direct connection with the first system after performing a system installation and setting a network configuration, while the first system records the second identification code into the built-in direct connection list; if the first identification code is correspondingly recorded in the built-in security list, then the connection request is received to establish the direct connection; on the other hand, if a non-corresponding first identification code is recorded, the first system is requested to provide the PIN code in order to establish the direct connection after the confirmation; if the second identification code is recorded in the built-in direct connection list, the first system transmits the connection request to the second system according to the second identification code, and if the second system confirms that the first identification code is correspondingly recorded in the built-in security list, a direct connection is established; if no data is recorded in the built-in security list, the first identification code is recorded, and the first system is requested to perform a setup and an online connection after providing the set parameter; after the online connection, the first system transmits a service request to the second system through the application program, so that the processing unit drives the transmission unit and the first system to perform a data transmission or synchronization according to the service request.

2. The peer-to-peer wireless transmission system of claim 1, wherein if one single first identification code and the PIN code are recorded in the built-in security list and plural second systems are used, the application program defines one of the second identification codes as a record of the built-in direct connection list, and the application program sets an automatic scheduling procedure, such that when the automatic scheduling procedure is triggered, the first system automatically authorizes the online connection to the second system corresponding to the record of the built-in direct connection list.

3. The peer-to-peer wireless transmission system of claim 2, further comprising a third system, and the first system using the application program to search and transmit the connection request to the third system, such that after the third system receives the connection request, an online connection is established for transmitting or synchronizing the data with one another, or the first system uses the application program to output the PIN code to the third system to authorize the third system to transmit or synchronize the data correspondingly with the second system.

4. The peer-to-peer wireless transmission system of claim 3, wherein the second system includes a storage unit electrically coupled to the processing unit for storing the data.

5. The peer-to-peer wireless transmission system of claim 4, wherein the data are original or lossless compression audio stream data, and the second system includes an audio unit electrically coupled to the processing unit, such that the second system drives the audio unit to play back the audio stream data according to the service request.

6. The peer-to-peer wireless transmission system of claim 1, wherein the second system is installed with a wireless network chip and combined with a Bluetooth chip, a near field communication chip, a GPS chip, a wireless power supply chip, a RFID system chip, or a combination thereof.

7. A peer-to-peer wireless transmission method, applied in the peer-to-peer wireless transmission system according to claim 1, and a communication method between the first system and the second system comprising the steps of:
turning on the application program and the second system;
searching the second system to read the second identification code and examining the built-in direct connection list by the application program;
transmitting the connection request with the first identification code and the set parameter with the PIN code to the second system if no data is recorded in the built-in direct connection list;
recording the first identification code after the second system receives the connection request and automatically checks the built-in security list if no data is recorded in the built-in security list, and using the set parameter to perform the system installation and set the network configuration to establish the direct connection with the first system, while the first system records the second identification code to the built-in direct connection list, and receives the connection request to establish the direct connection if the first identification code is correspondingly recorded in the built-in security list, and on the other hand, the first system is requested to provide the PIN code and establish the direct connection after the confirmation if the non-corresponding first identification code is recorded;
transmitting the connection request to the second system by the first system according to the second identification code if the second identification code is recorded in the built-in direct connection list;
establishing the direct connection of the second system after the first identification code is correspondingly confirmed to be recorded in the built-in security list, and recording the first identification code if no data is recorded in the built-in security list, and requesting the first system to perform the setup and the online connection after the set parameter is provided; and
clicking the application program, such that the first system transmits the service request to the second system to transmit or synchronize data.

8. The peer-to-peer wireless transmission method of claim 7, wherein if one single first identification code and the PIN code are recorded in the built-in security list, and plural second systems are used, the method further comprises the steps of:
using the application program to define one of the second identification codes as a record of the built-in direct connection list, and setting the automatic scheduling procedure; and
automatically authorize the online connection to the second system with the corresponding to the record of the built-in direct connection list by the first system if the automatic scheduling procedure is triggered.

9. The peer-to-peer wireless transmission method of claim 8, wherein after the first system is started, the method further comprises the steps of:
searching and transmitting the connection request to a third system by the application program of the first system, and establishing the online connection after the third system receives the connection request; and
transmitting or synchronizing the data, or providing the PIN code to the third system by the application program of the first system to authorize the third system and the second system correspondingly to transmit or synchronize the data with each other.
